(19) United States
(12) Patent Application Publication
(10) Pub. No.: US 2025/0330503 A1
(43) Pub. Date: Oct. 23, 2025

(54) CONTENT SHARING

(71) Applicant: Beijing Zitiao Network Technology Co., Ltd., Beijing (CN)

(72) Inventors: Chongsheng WANG, Beijing (CN); Weidong Wang, Beijing (CN)

(21) Appl. No.: 19/094,693

(22) Filed: Mar. 28, 2025

(30) Foreign Application Priority Data
Apr. 22, 2024 (CN) 202410487444.6

(51) Int. Cl. H04L 65/40; G06F 3/0481

(52) U.S. Cl. CPC H04L 65/40; G06F 3/0481

(57) ABSTRACT

According to embodiments of the disclosure, a method, an apparatus, a device, and a storage medium for content sharing are provided. The method includes: in response to target content being shared to a chat, displaying a prompt message of the target content being shared in an interface of the chat; and displaying, in association with the prompt message, sharing recommendation information indicating one or more objects. Thus, the target content may be shared with the one or more objects based on the sharing recommendation information, which helps to improve the collaboration efficiency of the target content.

### CROSS-REFERENCE

The present application claims priority to Chinese Patent Application No. 202410487444.6, filed on Apr. 22, 2024, and entitled “METHOD, APPARATUS, DEVICE AND STORAGE MEDIUM FOR CONTENT SHARING”, the entirety of which is incorporated herein by reference.

### FIELD

Example embodiments of the present disclosure relate to the field of computer in general, and in particular, to content sharing.

### BACKGROUND

Sending content through instant messaging (IM) is a common means of sharing documents. However, some content (such as a document) has a larger scope of collaboration than other content. In the process of sharing, it may be necessary for a user to manually add collaborators or send content multiple times through IM before more collaborators can be added with authorization, which leads to insufficient collaboration efficiency.

### SUMMARY

In a first aspect of the present disclosure, a method for content sharing is provided. The method includes: in response to target content being shared to a chat, displaying in an interface of the chat a prompt message of the target content being shared; and displaying, in association with the prompt message, sharing recommendation information indicating one or more objects.

In a second aspect of the present disclosure, an apparatus for content sharing is provided. The apparatus includes: a prompt message display module configured to, in response to target content being shared to a chat, display in an interface of the chat a prompt message of the target content being shared; and a sharing recommendation information display module configured to display, in association with the prompt message, sharing recommendation information indicating one or more objects.

In a third aspect of the present disclosure, an electronic device is provided. The device includes at least one processing unit; and at least one memory coupled to the at least one processing unit and storing instructions executable by the at least one processing unit, the instructions, when executed by the at least one processing unit, causing the device to perform the method of the first aspect.

In a fourth aspect of the present disclosure, a computer-readable storage medium is provided. The computer-readable storage medium has a computer program stored thereon, and the computer program is executable by a processor to implement the method of the first aspect.

It should be understood that the content described in this section is not intended to identify key features or essential features of the embodiments of the present disclosure, nor is it intended to limit the scope of the present disclosure. Other features of the present disclosure will become readily apparent from the following description.

### BRIEF DESCRIPTION OF THE DRAWINGS

The above and other features, advantages, and aspects of various embodiments of the present disclosure will become more apparent in combination with the drawings and with reference to the following detailed description. In the drawings, the same or similar reference numbers refer to the same or similar elements, where:

FIG. 1 shows a schematic diagram of an example environment in which embodiments of the present disclosure can be implemented;

FIG. 2A shows a schematic diagram of an example of an interface of a chat according to some embodiments of the present disclosure;

FIG. 2B shows a schematic diagram of another example of an interface of a chat according to some embodiments of the present disclosure;

FIG. 3A shows a schematic diagram of an example of an interface where content sharing is triggered according to some embodiments of the present disclosure;

FIG. 3B shows a schematic diagram of another example of an interface where content sharing is triggered according to some embodiments of the present disclosure;

FIG. 4 shows a schematic diagram of an example of an interface where content sharing is cancelled according to some embodiments of the present disclosure;

FIG. 5 shows a flowchart of an example of a method for content sharing according to some embodiments;

FIG. 6 shows a block diagram of an apparatus for content sharing according to some embodiments of the present disclosure; and

FIG. 7 shows a block diagram of a device capable of implementing multiple embodiments of the present disclosure.

### DETAILED DESCRIPTION

It can be understood that, before using the technical solutions disclosed in the embodiments of the present disclosure, a user should be informed of the type, scope of use, use scenario, etc. of the personal information involved in the present disclosure in an appropriate manner in accordance with relevant laws and regulations, and the user's authorization should be obtained.

For example, in response to receiving an active request from a user, prompt information is sent to the user to explicitly prompt the user that the operation requested by the user will require the acquisition and use of the user's personal information. Thus, the user can independently choose whether to provide personal information to software or hardware such as an electronic device, an application, a server, or a storage medium that performs the operations of the technical solutions of the present disclosure, according to the prompt information.

As an optional but non-limiting implementation, the manner of sending prompt information to the user in response to receiving an active request from the user may be, for example, a pop-up window, and the prompt information may be presented in the form of text in the pop-up window. In addition, the pop-up window may also carry a selection control for the user to select “agree” or “disagree” to provide personal information to the electronic device.

It can be understood that the above process of notifying and acquiring the user's authorization is only illustrative, and does not limit the implementations of the present disclosure. Other methods that meet relevant laws and regulations may also be applied to the implementations of the present disclosure.

It can be understood that the data involved in this technical solution (including but not limited to the data itself, the acquisition or use of data) should comply with the requirements of corresponding laws, regulations, and related provisions.

Hereinafter, embodiments of the present disclosure will be described in more detail with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for exemplary purposes, and are not used to limit the protection scope of the present disclosure.

It should be noted that the headings of any sections/subsections provided herein are not limiting. Various embodiments are described throughout this article, and any type of embodiment may be included under any section/subsection. Furthermore, the embodiments described in any section/subsection may be combined in any way with any other embodiments described in the same section/subsection and/or different sections/subsections.

In this article, unless explicitly stated, performing a step “in response to A” does not mean that the step is performed immediately after “A”, but may include one or more intermediate steps.

In the description of the embodiments of the present disclosure, the term “include” and similar terms should be understood as open inclusion, that is, “include but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may be included below. The terms “first”, “second”, etc. may refer to different or the same objects. Other explicit and implicit definitions may be included below.

### Example Environment

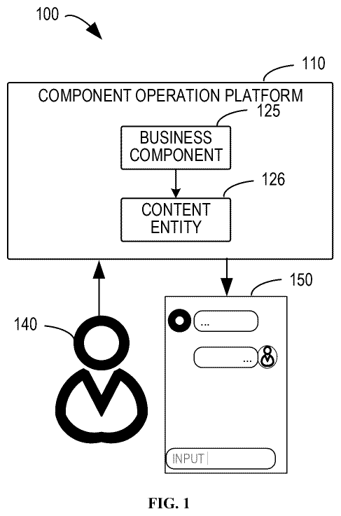

FIG. 1 shows a schematic diagram of an example environment 100 in which embodiments of the present disclosure can be implemented. In this example environment 100, a component operation platform 110 can support the operation of a business component 125. A user 140 can interact with the business component 125 through a client of the component operation platform 110.

In some embodiments, the business component 125 can be downloaded and installed on a terminal device of the user 140. In some embodiments, the business component 125 may also be accessed in other ways, such as through a web page. In the environment 100 of FIG. 1, in response to the business component 125 being started, the client of the component operation platform 110 can present an interface 150 of the business component 125.

The business component 125 includes but is not limited to one or more of the following: a chat business component (also known as an instant messaging business IM component), a document business component, an audio and video conference business component, an email business component, a task business component, a calendar business component, an objective and key result (OKR) business component, and so on. It can be understood that although a single business component is shown in FIG. 1, multiple business components can actually be installed on the terminal device 110. Multiple business components can be integrated on the component operation platform 110, and such component operation platforms 110 can be regarded as multi-functional collaboration platforms. In the case where multiple business components are installed on the terminal device 110, these multiple business components can be integrated on one or more component operation platforms 110. In the component operation platform 110, people can start different business components as needed to complete corresponding information processing, sharing, communication, etc. The business component 125 can provide a content entity 126. The content entity 126 may be a content instance created by the user 140 or other users on the business component 125. For example, depending on the type of the business component 125, the content entity 126 may be a document (for example, a word document, a pdf document, a presentation, a spreadsheet document, etc.), an email, a message (for example, a chat message on an instant messaging business component), a calendar, a schedule, a task, an audio, a video, an image, and so on.

In some embodiments, the component operation platform 110 may provide a digital assistant 120. The digital assistant 120 may be provided by a separate business component, or may be integrated into a certain business component 120 that can provide a content entity. The business component for providing a client interface for the digital assistant may correspond to a single-function business component or a multi-functional collaboration platform, such as an office suite or other collaboration platforms that can integrate multiple components. It can be understood that, similar to the business component, although a single digital assistant is shown in FIG. 1, there can actually be multiple digital assistants.

The component operation platform 110 may be deployed locally on the terminal device of each user 140, and/or may be supported by a server-side device. For example, the terminal device of the user 140 may run the client of the component operation platform 110, and the client may support the interaction between the user 140 and the component operation platform 110 provided by the server-side. In the case where the component operation platform 110 runs locally on the user's terminal device, the user 140 may directly interact with the local component operation platform 110 using the terminal device. In the case where the component operation platform 110 runs on the server-side device, the server-side device may realize the service provision to the client running in the terminal device based on the communication connection with the terminal device. The component operation platform 110 may present the corresponding interface 150 to the user 140 based on the operation of the user 140, to output information related to the use of the component to the user 140 and/or receive information related to the use of the component from the user 140.

The component operation platform 110 may run on suitable electronic devices. Here, the electronic device may be any type of device with computing power, including a terminal device or a server-side device. The terminal device may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including accessories and peripherals of these devices, or any combination thereof. The server-side device may include, for example, a computing system/server, such as a mainframe, an edge computing node, a computing device in a cloud environment, and so on. In some embodiments, the component operation platform 110 may be implemented based on cloud services.

It should be understood that the structure and function of the environment 100 are described only for the purpose of illustration, without implying any limitation to the scope of the present disclosure.

In the process of using one or more business components to process content (for example, various documents), a user may need to collaborate with other users on a certain content, and therefore the content needs to be shared with these users. Conventionally, sending through IM to share content is a common means of sharing content. At present, some applications already support sending content through IM, and will give authorization to receivers. However, some content requires a larger scope of collaboration for sharing. In the process of sharing, it may be necessary for a user to manually add collaborators or send the content multiple times through IM before more collaborators can be added with authorization. This leads to insufficient collaboration efficiency and poor user experience.

In view of this, embodiments of the present disclosure provide a solution for content sharing. According to various embodiments of the present disclosure, if target content is shared to a chat, a prompt message of the target content being shared is displayed in an interface of the chat. Further, sharing recommendation information is displayed in association with the prompt message. The sharing recommendation information indicates one or more objects. Thus, the target content may be shared with the one or more objects based on the sharing recommendation information. This helps to improve the collaboration efficiency of the target content.

Hereinafter, some example embodiments of the present disclosure will be described with continued reference to the drawings. It should be understood that the interfaces shown in the drawings are only examples, and various interface designs may actually exist. Each graphic element in the interface may have different arrangements and different visual representations, one or more of the elements may be omitted or replaced, and one or more other elements may also exist. The embodiments of the present disclosure are not limited in this regard. In addition, in the following, example embodiments will be mainly described with respect to the component operation platform 110. It should be understood that the actions described with respect to the component operation platform 110 may be implemented by a client and/or a server of the component operation platform 110. For example, the actions may be performed by an application, a component, or a suite (for example, the business component 125) running on the terminal device, or may be performed by the application, the component, or the suite in cooperation with its server.

### Schematic Diagrams of Example Interfaces

If the target content is shared to the chat, the component operation platform 110 may display, in an interface 150 of the chat, a prompt message of the target content being shared. Further, the component operation platform 110 may display, in association with the prompt message, sharing recommendation information indicating one or more objects. That is, the sharing recommendation information recommends the user to share the target content with the one or more objects. The target content may be content that can be sent in the chat, such as, but not limited to, at least one of: a document, a web page, a video, task information, approval information, conference information, and email information. In the following, a document is mainly taken as an example of the target content for description, but it should be understood that this is only exemplary and not intended to be limiting. The chat may be a single chat between two users. In particular, the chat may be a group chat including multiple users.

In the embodiments of the present disclosure, the content being shared may authorize the shared object a permission of a predetermined level related to the content. For example, the content being shared may grant the shared object the read permission of the content. Correspondingly, the target content being shared to the chat may grant the members in the chat the read permission of the content.

In some embodiments of the present disclosure, the target content being shared to the chat includes any of the following cases: being shared to a second chat through a share control of the target content interface or a share control of the first chat interface, the target content or a carrier pointing to the target content being presented in the form of a chat message in the second chat interface; the carrier pointing to the target content being acquired, sent in the form of a chat message in the chat interface and presented in the chat.

The prompt message and the sharing recommendation information may be displayed in the interface of the chat in any suitable form. In some embodiments, the prompt message may be displayed in the form of a message card, and the sharing recommendation information may be displayed in the message card.

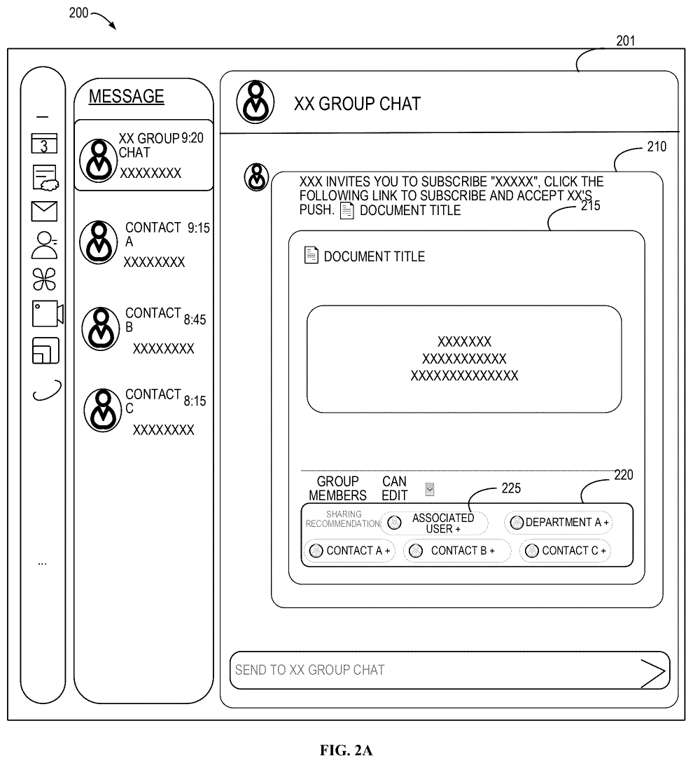

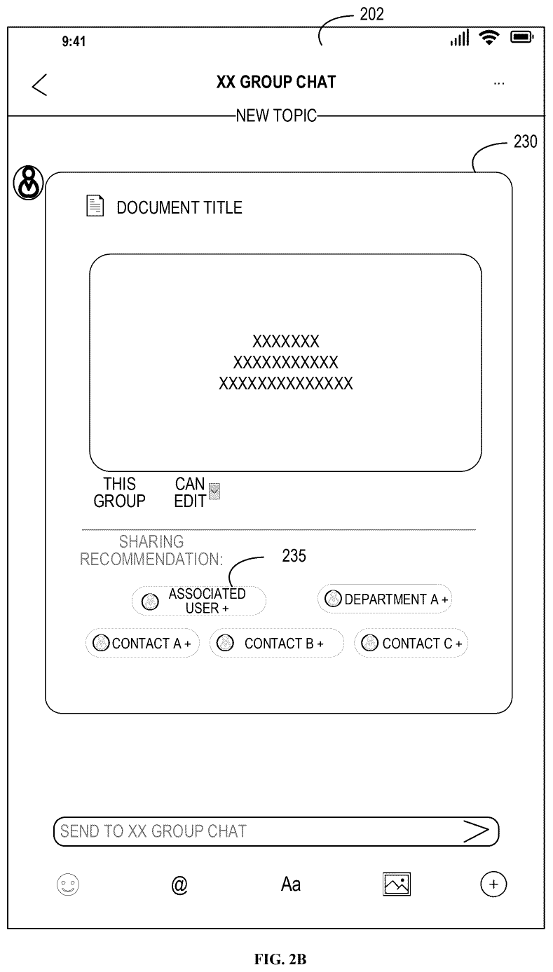

Examples are described below with reference to FIG. 2A and FIG. 2B. FIG. 2A shows a schematic diagram of an example of an interface of a chat according to some embodiments of the present disclosure. The interface as shown in FIG. 2A may be implemented in one type of device, for example, in a portable computer, a general-purpose computer.

In this example, a document is shared to the chat (in this example, an XX group chat). Accordingly, a message card 210 is displayed in an interface 201 of the chat to prompt that the document is shared. The message card 210 includes text prompt information, target content title and target content information 215. The target content information 215 includes a title of the target content, a part or summary of the target content, and a sharing recommendation information box 220 for displaying the sharing recommendation information. As shown in FIG. 2A, the sharing recommendation information includes a text description “sharing recommendation” and corresponding information of one or more objects.

FIG. 2B shows a schematic diagram of another example of an interface of a chat according to some embodiments of the present disclosure. The interface as shown in FIG. 2B may be implemented in another type of device, such as a mobile phone.

In this example, a document is shared to the chat (in this example, an XX group chat). Accordingly, a message card 230 is displayed in an interface 202 of the chat to prompt that the document is shared. The message card 230 includes target content information, which includes a title of the target content, the content of the target content, and sharing recommendation information. As shown in FIG. 2B, the sharing recommendation information includes a text description “sharing recommendation” and corresponding information of one or more objects.

The one or more recommended objects may include various suitable users or user communities. In some embodiments, the sharing of the target content may be triggered by a first user. For example, the first user sends the target content to the chat. The one or more objects may include at least one of: a user having a predetermined association relationship with the first user, a user community, the user community and the first user belonging to a same user group, or one or more users who perform content collaboration with the first user.

For example, the user having the predetermined association relationship with the first user may be an associated user of the first user (for example, a superior of the first user), such as the “associated user” shown in FIG. 2A and FIG. 2B. The user community belonging to the same user group to which the first user belongs may include various users who belong to the same part as the first user, such as “Department A” shown in FIG. 2A and FIG. 2B. The one or more users who perform content collaboration with the first user may include other users who collaborate with the first user in recent period or users who collaborate with the first user with high frequency, such as “Contact A”, “Contact B”, and “Contact C” shown in FIG. 2A and FIG. 2B. The one or more objects may also include a digital assistant.

In some embodiments, the one or more recommended objects may satisfy some conditions. As an example, a certain object of the one or more objects may not be a member of the current chat. For example, if a chat member automatically acquires the read permission of the document shared in the chat, the recommended object is not a member of the current chat. As another example, a certain object of the one or more objects may be a member of the current chat, but is not automatically authorized after the target document is sent. For example, if the target document is set with a relatively high permission level, and some members in the current chat are outside this permission level, such members may become the recommended objects.

In some embodiments, the target content is shared to the chat by a first user, and the sharing recommendation information box 220 indicates sharing the target content with the one or more recommended objects. The target content may be shared through the IM. As an example, the first user creates a document, and shares the document through the IM for collaboration. After sharing the document, the sharing recommendation information is displayed in the message card. The sharing recommendation information indicates the first user to share the document with an associated user, department A, and recently collaborated users corresponding to the first user, such as user A, user B, etc.

In some embodiments, the sharing recommendation information includes indication information of one or more objects. For example, if the object is a user having a predetermined association relationship with the first user, for example, an “associated user”, the indication information of the object may include avatar information and name of the user “associated user”, and the predetermined association relationship between the object “associated user” and the first user. For another example, if the object is a user community that the user community and the first user belong to a same user group, which may be a group, such as department A, the indication information of the object may include name information and an icon of the group. For another example, if the object is one or more users or a digital assistant who perform content collaboration with the first user, such as contact A, contact B, contact C, the indication information associated with the target object may include avatar information and name information of these contacts.

In some embodiments, the sharing recommendation information may include a share control for the object. For example, a “+” identification as a share control is displayed in the “associated user” display area 225.

In some embodiments, in response to detecting a sharing operation on a target object of the one or more objects, the component operation platform 110 may share the target content with the target object, for example, grant the target object the read permission of the target content. The sharing operation may be detected in the interface of the chat. The sharing operation may be any suitable predetermined trigger operation. Accordingly, the component operation platform 110 may display identification information of the target content being shared with the target object. In some embodiments, such identification information may replace the previously displayed sharing control.

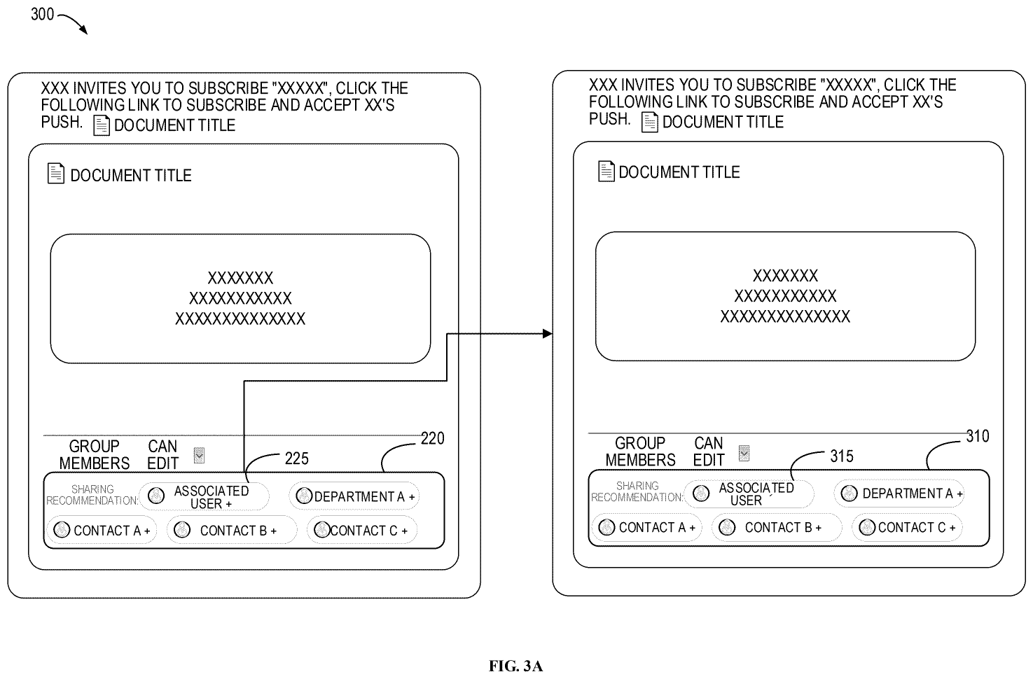

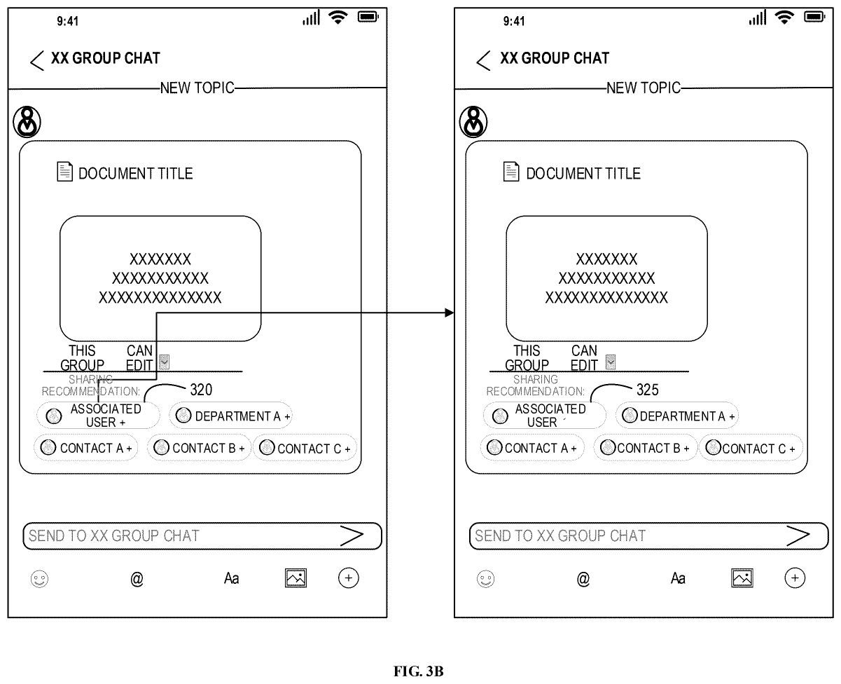

FIG. 3A shows a schematic diagram of an example of an interface where content sharing is triggered according to some embodiments of the present disclosure. The interface as shown in FIG. 3A may be implemented in one type of device, for example, in a portable computer, a general-purpose computer.

As shown in FIG. 3A, when no sharing operation is performed, the sharing recommendation information box 220 is displayed, in which a “+” identification, also known as a “to-be-selected” identification. is displayed as a sharing control. When a sharing operation has been performed, the corresponding sharing recommendation information box 310 is displayed. The identification corresponding to the “associated user” display area 225 in the sharing recommendation information box 220 is a “to-be-selected” identification. The “to-be-selected” identification indicates that the “associated user” has not been shared with the target document. The identification corresponding to the “associated user” display area 315 in the sharing recommendation information box 310 is a “selected” identification, that is, the “check” identification in the drawings. The “selected” identification indicates that the “associated user” is in a selected state, that is, the “associated user” has been shared with the target document. That is, the “to-be-selected” identification as the sharing control is replaced by the “check” identification to indicate that the target content has been shared with the corresponding object.

The sharing recommendation information box 220 and the sharing recommendation information box 310 may include information of one or more objects. For example, the “associated user” display area 225 may include avatar information, the text “associated user” and a corresponding “to-be-selected” identification (for example. the “+” identification). The “associated user” display area 315 may include avatar information, the text “associated user” and a corresponding identification (for example, the “check” identification).

In some embodiments, the sharing operation may be a trigger of the indication information of the target object. For example, the sharing operation may be a click on any place inside the “associated user” display area 225. Alternatively or additionally, in some embodiments, the sharing operation may be a trigger of the sharing control of the target object. As an example, the sharing operation may be a click on the “to-be-selected” identification, that is, the “+” identification of the “associated user” display area 225.

FIG. 3B shows a schematic diagram of another example of an interface where content sharing is triggered according to some embodiments of the present disclosure. The interface as shown in FIG. 3B may be implemented in another type of device, for example, in may be implemented in a mobile phone.

As shown in FIG. 3B, when no sharing operation is performed, the “associated user” display area 320 in the sharing recommendation information is displayed. When a sharing operation has been performed, the “associated user” display area 325 in the sharing recommendation information is displayed. The identification corresponding to the “associated user” display area 320 is a “to-be-selected” identification. The “to-be-selected” identification indicates that the “associated user” is in a to-be-selected state, that is, the “associated user” has not been selected as the target object. The identification corresponding to the “associated user” display area 325 is a “selected” identification. The “selected” identification indicates that the “associated user” is in a selected state, that is, the “associated user” has been selected and taken as the target object.

The sharing recommendation information may include information of one or more objects. For example, the “associated user” display area 320 may include avatar information, the text “associated user” and a corresponding identification. The “associated user” display area 325 may include avatar information, the text “associated user” and a corresponding identification.

As an example, the sharing operation may be a click on the “to-be-selected” identification of the “associated user” display area 320, or may be a click on any place inside the “associated user” display area 320, and the message card may be an IM document card.

As an example, the document may be shared with the recommended target object based on the IM document card. For example, by clicking on the “to-be-selected” identification on the right of the recommended target object, the target object may be granted the “read” permission.

In some embodiments, after the target content is shared with the target object, a sharing cancellation operation on the target object is detected, for example, the sharing cancellation operation is detected in the interface of the chat. In response to the sharing cancellation operation, the sharing of the target content with the target object may be cancelled, and the display of the identification information may be stopped.

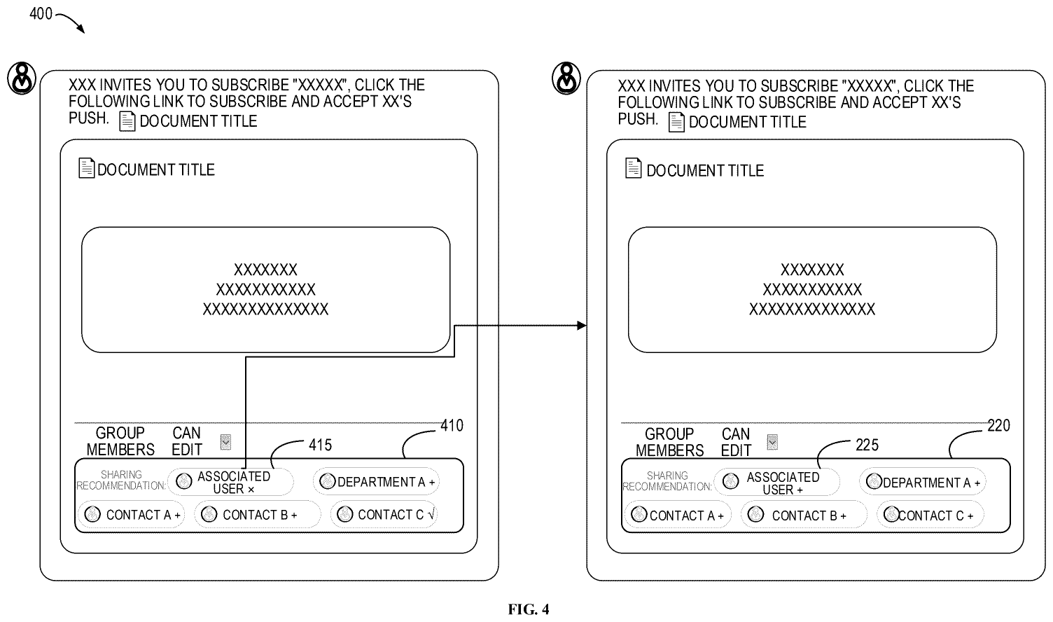

FIG. 4 shows a schematic diagram of an example of an interface where content sharing is cancelled according to some embodiments of the present disclosure. The interface as shown in FIG. 4 may be implemented in one type of device, for example, in a portable computer, a general-purpose computer.

In some embodiments, a hover over the “associated user” display area 315 may cause a display of the cancel identification shown in FIG. 4, that is, the “x” identification. The identification corresponding to the “associated user” display area 415 is a cancel identification, indicating that the “associated user” is in a selected state, and a click on the cancel identification can cancel the selected state of the “associated user”.

As an example, the sharing cancellation operation on the target object may be a click on the cancel identification in the “associated user” display area 415. If it is detected that the cancel identification in the “associated user” display area 415 is clicked, the sharing of the target content with the “associated user” is cancelled, and the display of the cancel identification is stopped. The sharing cancellation operation may also be a click on any place inside the “associated user” display area 415.

As shown in FIG. 4, when no sharing cancellation operation is performed, the sharing recommendation information box 410 is displayed, and when the sharing cancellation operation is performed, the sharing recommendation information box 220 is displayed. The identification corresponding to the “associated user” display area 415 in the sharing recommendation information box 410 is a cancel identification. The cancel identification indicates that the “associated user” is in a selected state and the selected state of the “associated user” may be cancelled. The identification corresponding to the “associated user” display area 225 in the sharing recommendation information box 220 is a “to-be-selected” identification. The “to-be-selected” identification indicates that the “associated user” is in a to-be-selected state.

The sharing recommendation information box 410 and the sharing recommendation information box 220 may include information of one or more objects. For example, the “associated user” display area 415 may include avatar information, the text “associated user” and a corresponding identification. The “associated user” display area 225 may include avatar information, the text “associated user” and a corresponding identification.

As an example, if a document has been shared with a recommended target object based on the IM document card, and the target object is granted a “read” permission, the “read” permission of the target object may be cancelled through the IM document card. For example, a click on the cancel identification on the right of the recommended target object may cause the “read” permission of the target object to be cancelled.

In some embodiments, in response to a number of times that the first user shares content with the second user exceeding a threshold, configuration guidance information is displayed, indicating that content shared by the first user is to be automatically shared with the second user having a predetermined association relationship with the first user.

As an example, the second user having the predetermined association relationship with the first user may be an “associated user”, and the preset threshold is 5 times. If the first user shares content with the “associated user” for the sixth time, the configuration guidance information is displayed, instructing the first user to perform settings of automatic sharing of the content with the “associated user”.

In some embodiments, the threshold may be obtained based on presetting, and a configuration guidance interface may be implemented in one type of device, such as in a portable computer, a general-purpose computer. The configuration guidance information interface may include a title of the configuration guidance information. For example, “Set up automatic granting of read permissions for associated users”. The configuration guidance information interface may also include the content of the configuration guidance information. For example, “To promote information flow within the organization, it is recommended to enable “Automatically grant read permissions to associated users when sharing documents”. You can modify the settings in “Settings-Documents”.” The configuration guidance information interface may also include selection areas corresponding to different options, for example, “Only add this time”. A trigger of the “Only add this time” area means that the “associated user” is only granted the read permission this time. For example, “Confirm” may be used to indicate confirmation of the configuration guidance information, and a trigger of the “Confirm” area means that the “associated user” is to be granted the read permission.

As an example, when the number of times of sharing with the “associated user” exceeds a predetermined threshold, a settings interface is displayed to the first user, and the settings interface is used for a selection of automatic granting of the “read” permission for the “associated user” when the document is shared.

In some embodiments, the threshold may be obtained based on presetting, and a configuration guidance interface may be implemented in another type of device, such as a mobile phone. The configuration guidance information interface may include a title. For example, “Set up automatic granting of read permissions for associated users”. The configuration guidance information interface may also include the content of the configuration guidance information. For example, “You have given authorization to the associated user many times. Do you want to set up to share documents subsequently with default grant of the read permission for the associated user? You can modify the settings in “Settings-Documents”.” The configuration guidance information interface may also include selection areas corresponding to different options, for example, “Only authorize this time”. A trigger of the “Only authorize this time” area means that the “associated user” is only granted the read permission this time. For example, “Confirm” may be used to indicate confirmation of the configuration guidance information, and a trigger of the “Confirm” area means that the “associated user” is to be granted the read permission.

In some embodiments, in response to confirmation of the configuration guidance information, the automatic sharing configuration is brought into effect. The target content is shared with the second user according to the automatic sharing configuration corresponding to the predetermined association relationship, and the sharing recommendation information includes identification information of the target content being shared with the second user, and the identification of the target content being shared with the second user may correspond to a “selected” identification.

As an example, if the configuration guidance information is confirmed, the content shared by the first user is to be automatically shared with the “associated user”, and the identification corresponding to the sharing recommendation information of the “associated user” is the “selected” identification.

In some embodiments, a settings interface may be implemented in one type of device, such as in a portable computer, a general-purpose computer. In the document area of the settings interface, the default access permission of a new document may be set in the document setting display area. The default access permission of the new document may be selected by an access permission selection box to grant an object the access permission. The object to be granted access permission may be selected by a click on a drop-down area on the right side of the access permission selection box. For example, if the object to be granted access permission is department A, the permission selection box will display “Anyone in department A who obtains the link . . . ”.

In some embodiments, after an object to be granted access permission has been selected, a checkmark may be displayed in a check area corresponding to the default access permission of the new document. The checkmark identifies that the default access permission of the new document is executed based on the object selected to be granted access permission. If the checkmark is not displayed, it means that the default access permission of the new document is not executed based on the object selected to be granted access permission.

In some embodiments, it is also possible to set in the document setting display area whether to grant a user with a predetermined relationship with the first user the access permission, for example, in a display area of “Automatically grant associated user read permission when sharing document”. After the “associated user” has been selected to be granted the access permission, a checkmark is displayed in the check area corresponding to the display area. The checkmark indicates that the associated user is automatically granted the read permission when the document is shared. After the settings are enabled, the sharing recommendation information is still displayed when the target content is shared, and the “associated user” is in a checked state. If the checkmark is not displayed, it means that the “associated user” is not granted the read permission automatically when the document is shared.

In some embodiments, a settings interface may be implemented in another type of device, such as in a mobile phone. The default access permission of a new document may be set in the settings interface. The default access permission of the new document may be selected by an access permission selection box to grant an object the access permission. The object to be granted access permission may be selected by a click on a selection area on the right side of the access permission selection box. For example, if the object to be granted access permission is department A, the permission selection box will display “Department A”. The default access permission of the new document is executed based on the object selected to be granted access permission.

In some embodiments, it is also possible to set in the document setting display area whether to grant a user with a predetermined relationship with the first user the access permission. For example, in a display area of “Automatically grant associated user read permission when sharing document”, after the “associated user” has been selected to be granted the access permission, a “selected” identification may be displayed in the selection area corresponding to the display area. The “selected” identification indicates that the associated user is automatically granted the read permission when the document is shared. After the settings are enabled, the sharing recommendation information is still displayed when the target content is shared, and the “associated user” is in a checked state. If the checkmark is not displayed, it means that the “associated user” is not granted the read permission automatically when the document is shared.

In summary, the target content can be shared with one or more objects based on the sharing recommendation information, which can improve collaboration efficiency and improve user experience.

### Example Process

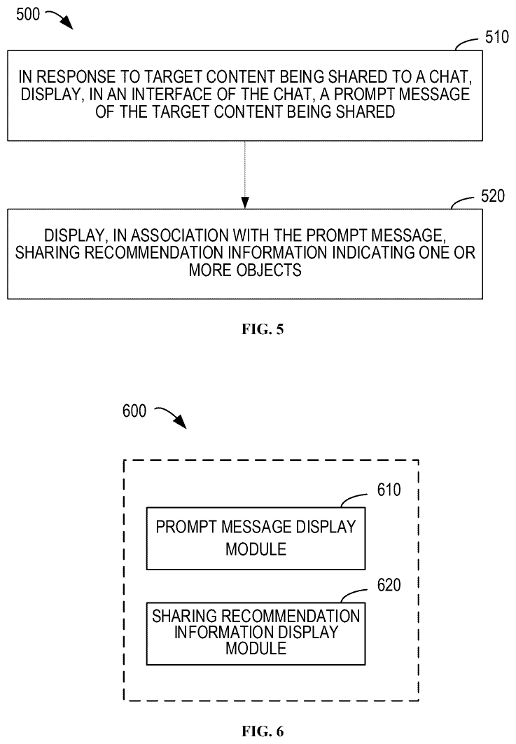

FIG. 5 shows a flowchart of an example of a process 500 for content sharing according to some embodiments. The process 500 may be implemented at the component operation platform 110. The process 500 will be described below with reference to the environment 100 of FIG. 1.

At block 510, in response to target content being shared to a chat, the component operation platform 110 displays, in an interface of the chat, a prompt message of the target content being shared.

At block 520, the component operation platform 110 displays, in association with the prompt message, sharing recommendation information indicating one or more objects.

In some embodiments, the prompt message is displayed in a form of a message card, and the sharing recommendation information is displayed in the message card.

In some embodiments, the component operation platform 110, in response to detecting a sharing operation on a target object of the one or more objects, shares the target content with the target object; and displays identification information of the target content being shared with the target object.

In some embodiments, after the target content is shared with the target object, the component operation platform 110, in response to detecting a sharing cancellation operation on the target object, cancels sharing of the target content with the target object; and stops displaying the identification information.

In some embodiments, the sharing recommendation information includes indication information of the target object and a share control for the target object, and the sharing operation includes at least one of: a trigger of the indication information, or a trigger of the share control.

In some embodiments, displaying the identification information of the target content being shared with the target object includes: replacing the share control with the identification information.

In some embodiments, the sharing of the target content is triggered by a first user, the one or more objects include a second user having a predetermined association relationship with the first user, and the method 500 further includes: sharing the target content with the second user according to an automatic sharing configuration corresponding to the predetermined association relationship, and the sharing recommendation information includes identification information of the target content being shared with the second user.

In some embodiments, the automatic sharing configuration is brought into effect through the following operations: in response to the number of times that the first user shares content with the second user exceeding a threshold, displaying configuration guidance information indicating that content shared by the first user is to be automatically shared with the second user having the predetermined association relationship with the first user; and in response to confirmation of the configuration guidance information, bring the automatic sharing configuration into effect.

In some embodiments, the sharing of the target content is triggered by a first user, and the one or more objects include at least one of: a user having a predetermined association relationship with the first user, a user community, the user community and the first user belonging to a same user group, or one or more users who perform content collaboration with the first user.

In some embodiments, the one or more objects respectively satisfy one of the following conditions: not being a member of the chat, or being a member of the chat, and not being authorized after the target document is shared to the chat.

### Example Apparatus And Device

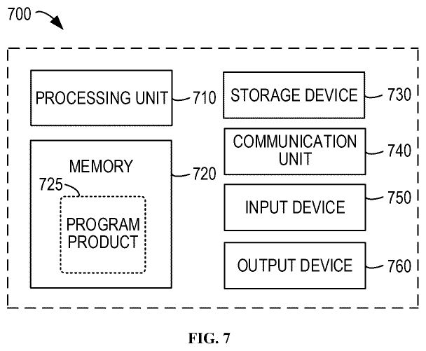

FIG. 6 shows a schematic structural block diagram of an apparatus 600 for content sharing according to some embodiments of the present disclosure. The apparatus 600 may be implemented as or included in the component operation platform 110. Each module/component in the apparatus 600 may be implemented by hardware, software, firmware, or any combination thereof.

As shown, the apparatus 600 includes a prompt message display module 610 configured to, in response to target content being shared to a chat, display a prompt message of the target content being shared in an interface of the chat. The apparatus 600 further includes a sharing recommendation information display module 620 configured to display, in association with the prompt message, sharing recommendation information indicating one or more objects.

In some embodiments, the prompt message is displayed in a form of a message card, and the sharing recommendation information is displayed in the message card.

In some embodiments, the prompt message display module 610 further includes a first execution module configured to, in response to a sharing operation on a target object of the one or more objects, share the target content with the target object; and an identification information display module configured to display identification information of the target content being shared with the target object.

In some embodiments, the prompt message display module 610 further includes a second execution module configured to, after the target content is shared with the target object, in response to detecting a sharing cancellation operation on the target object, cancel sharing of the target content with the target object; and an identification information display module configured to stop displaying the identification information.

In some embodiments, the sharing recommendation information includes indication information of the target object and a share control for the target object, and the sharing operation includes at least one of: a trigger of the indication information, or a trigger of the share control.

In some embodiments, the identification information display module is further configured to replace the share control with the identification information.

In some embodiments, the sharing of the target content is triggered by a first user, the one or more objects include a second user having a predetermined association relationship with the first user, and the sharing recommendation information display module 620 further includes a sharing module configured to share the target content with the second user according to an automatic sharing configuration corresponding to the predetermined association relationship, and the sharing recommendation information includes identification information of the target content being shared with the second user.

In some embodiments, the automatic sharing configuration is brought into effect through the following operations: in response to the number of times that the first user shares content with the second user exceeding a threshold, displaying configuration guidance information indicating that content shared by the first user is to be automatically shared with the second user having the predetermined association relationship with the first user; and in response to confirmation of the configuration guidance information, bring the automatic sharing configuration into effect.

In some embodiments, the sharing of the target content is triggered by a first user, and the one or more objects include at least one of: a user having a predetermined association relationship with the first user, a user community, the user community and the first user belonging to a same user group, or one or more users who perform content collaboration with the first user.

In some embodiments, the one or more objects respectively satisfy one of the following conditions: not being a member of the chat, or being a member of the chat, and not being authorized after the target document is shared to the chat.

FIG. 7 shows a block diagram of an electronic device 700 in which one or more embodiments of the present disclosure can be implemented. It should be understood that the electronic device 700 shown in FIG. 7 is only exemplary, and should not constitute any limitation to the functions and scope of the embodiments described herein. The electronic device 700 shown in FIG. 7 may be used to implement the component operation platform 110 of FIG. 1.

As shown in FIG. 7, the electronic device 700 is in the form of a general-purpose electronic device. The components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and can perform various processes according to programs stored in the memory 720. In a multi-processor system, multiple processing units execute computer-executable instructions in parallel to improve the parallel processing capability of the electronic device 700.

The electronic device 700 usually includes a plurality of computer storage media. Such media may be any available media accessible by the electronic device 700, including but not limited to volatile and non-volatile media, removable and non-removable media. The memory 720 may be a volatile memory (for example, a register, a cache, a random access memory (RAM)), a non-volatile memory (for example, a read-only memory (ROM), an electrically erasable programmable read-only memory (EEPROM), a flash memory), or a combination thereof. The storage device 730 may be a removable or non-removable medium, and may include a machine-readable medium, such as a flash drive, a disk, or any other medium, which may be capable of storing information and/or data and being accessed within the electronic device 700.

The electronic device 700 may further include additional removable/non-removable, volatile/non-volatile storage media. Although not shown in FIG. 7, a disk drive for reading from or writing to a removable, non-volatile disk (for example, a “floppy disk”) and an optical disk drive for reading from or writing to a removable, non-volatile optical disk may be provided. In these cases, each drive may be connected to a bus (not shown) by one or more data medium interfaces. The memory 720 may include a computer program product 725 having one or more program modules configured to perform various methods or actions of various embodiments of the present disclosure.

The communication unit 740 implements communication with other electronic devices through a communication medium. Additionally, the functions of the components of the electronic device 700 may be implemented by a single computing cluster or multiple computing machines that can communicate through communication connections. Therefore, the electronic device 700 may operate in a networked environment using a logical connection with one or more other servers, a network personal computer (PC), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown) through the communication unit 740 as required, the external devices such as storage devices, display devices, etc., communicate with one or more devices that enable the user to interact with the electronic device 700, or communicate with any device (for example, a network card, a modem, etc.) that enables the electronic device 700 to communicate with one or more other electronic devices. Such communication may be performed via an input/output (I/O) interface (not shown).

According to an example implementation of the present disclosure, a computer-readable storage medium is provided, on which computer-executable instructions are stored, and the computer-executable instructions are executed by a processor to implement the above-described method. According to an example implementation of the present disclosure, a computer program product is also provided, and the computer program product is physically stored on a non-transitory computer-readable medium and includes computer-executable instructions, and the computer-executable instructions are executed by a processor to implement the above-described method.

Various aspects of the present disclosure are described herein with reference to flowcharts and/or block diagrams of the method, apparatus, device and computer program product implemented according to the present disclosure. It should be understood that each block of the flowcharts and/or block diagrams and the combination of the blocks in the flowcharts and/or block diagrams may be implemented by computer-readable program instructions.

The computer-readable program instructions may be provided to the processing unit of a general-purpose computer, a special-purpose computer, or other programmable data processing apparatus, so as to produce a machine, so that these instructions, when executed by the processing unit of the computer or other programmable data processing apparatus, produce a device that implements the functions/acts specified in one or more blocks in the flowchart and/or block diagram. These computer-readable program instructions may also be stored in a computer-readable storage medium. These instructions cause the computer, programmable data processing apparatus, and/or other devices to work in a specific way. Thus, the computer-readable medium storing the instructions includes an article of manufacture, which includes instructions for implementing various aspects of the functions/acts specified in one or more blocks in the flowchart and/or block diagram.

The computer-readable program instructions may be loaded onto a computer, other programmable data processing apparatus, or other device, causing a series of operational steps to be performed on the computer, other programmable data processing apparatus, or other device to produce a computer-implemented process, so that the instructions executed on the computer, other programmable data processing apparatus, or other device implement the functions/acts specified in one or more blocks in the flowchart and/or block diagram.

The flowcharts and block diagrams in the drawings show possible architecture, functions, and operations of the system, method, and computer program product implemented according to multiple implementations of the present disclosure. In this regard, each block in the flowchart or block diagram may represent a module, a program segment, or a part of an instruction, and the module, the program segment, or the part of the instruction contains one or more executable instructions for implementing the specified logical function. In some alternative implementations, the functions marked in the blocks may also occur in a different order than the order marked in the drawings. For example, two consecutive blocks may actually be executed substantially in parallel, and they may sometimes be executed in a reverse order, depending on the functions involved. It should also be noted that each block in the block diagram and/or flowchart, and the combination of the blocks in the block diagram and/or flowchart, may be implemented by a dedicated hardware-based system that executes the specified functions or actions, or may be implemented by a combination of dedicated hardware and computer instructions.

Various implementations of the present disclosure have been described above, and the above description is exemplary, not exhaustive, and not limited to the disclosed implementations. Many modifications and changes are obvious to ordinary technical personnel in this technical field without departing from the scope and spirit of the described implementations. The selection of terms used in this article is intended to best explain the principles, practical applications, or improvements to technologies in the market of the implementations, or to enable other ordinary technical personnel in this technical field to understand the various implementations disclosed herein.

1. A content sharing method, comprising:
in response to target content being shared to a chat, displaying, in an interface of the chat, a prompt message of the target content being shared; and
displaying, in association with the prompt message, sharing recommendation information indicating one or more objects.

2. The method according to claim 1, wherein the prompt message is displayed in a form of a message card, and the sharing recommendation information is displayed in the message card.

3. The method according to claim 1, further comprising:
in response to a sharing operation on a target object of the one or more objects, sharing the target content with the target object; and
displaying identification information of the target content being shared with the target object.

4. The method according to claim 3, further comprising:
after the target content is shared with the target object, in response to detecting a sharing cancellation operation on the target object, cancelling sharing of the target content with the target object; and
stopping displaying the identification information.

5. The method according to claim 3, wherein the sharing recommendation information comprises indication information of the target object and a share control for the target object, and the sharing operation comprises at least one of:
a trigger of the indication information, or
a trigger of the share control.

6. The method according to claim 5, wherein displaying the identification information of the target content being shared with the target object comprises:
replacing the share control with the identification information.

7. The method according to claim 1, wherein the sharing of the target content is triggered by a first user, the one or more objects comprise a second user having a predetermined association relationship with the first user, and the method further comprises:
sharing the target content with the second user according to an automatic sharing configuration corresponding to the predetermined association relationship, and
wherein the sharing recommendation information comprises identification information of the target content being shared with the second user.

8. The method according to claim 7, wherein the automatic sharing configuration is brought into effect through the following operations:
in response to a number of times that the first user shares content with the second user exceeding a threshold, displaying configuration guidance information indicating that content shared by the first user is to be automatically shared with the second user having the predetermined association relationship with the first user; and
in response to confirmation of the configuration guidance information, bringing the automatic sharing configuration into effect.

9. The method according to claim 1, wherein the sharing of the target content is triggered by a first user, and the one or more objects comprise at least one of:
a user having a predetermined association relationship with the first user,
a user community, the user community and the first user belonging to a same user group, or
one or more users who perform content collaboration with the first user.

10. The method according to claim 1, wherein the one or more objects respectively satisfy one of:
a condition of not being a member of the chat, or
a condition of being a member of the chat and not being authorized after the target document is shared to the chat.

11. An electronic device, comprising:
at least one processing unit; and
at least one memory coupled to the at least one processing unit and storing instructions executable by the at least one processing unit, wherein the instructions, when executed by the at least one processing unit, cause the electronic device to perform acts comprising:
in response to target content being shared to a chat, displaying, in an interface of the chat, a prompt message of the target content being shared; and
displaying, in association with the prompt message, sharing recommendation information indicating one or more objects.

12. The device according to claim 11, wherein the prompt message is displayed in a form of a message card, and the sharing recommendation information is displayed in the message card.

13. The device according to claim 11, the acts further comprising:
in response to a sharing operation on a target object of the one or more objects, sharing the target content with the target object; and
displaying identification information of the target content being shared with the target object.

14. The device according to claim 13, the acts further comprising:
after the target content is shared with the target object, in response to detecting a sharing cancellation operation on the target object, cancelling sharing of the target content with the target object; and
stopping displaying the identification information.

15. The device according to claim 13, wherein the sharing recommendation information comprises indication information of the target object and a share control for the target object, and the sharing operation comprises at least one of:
a trigger of the indication information, or
a trigger of the share control.

16. The device according to claim 15, wherein displaying the identification information of the target content being shared with the target object comprises:
replacing the share control with the identification information.

17. The device according to claim 11, wherein the sharing of the target content is triggered by a first user, the one or more objects comprise a second user having a predetermined association relationship with the first user, and the acts further comprise:
sharing the target content with the second user according to an automatic sharing configuration corresponding to the predetermined association relationship, and
wherein the sharing recommendation information comprises identification information of the target content being shared with the second user.

18. The device according to claim 17, wherein the automatic sharing configuration is brought into effect through the following operations:
in response to a number of times that the first user shares content with the second user exceeding a threshold, displaying configuration guidance information indicating that content shared by the first user is to be automatically shared with the second user having the predetermined association relationship with the first user; and
in response to confirmation of the configuration guidance information, bringing the automatic sharing configuration into effect.

19. The device according to claim 11, wherein the sharing of the target content is triggered by a first user, and the one or more objects comprise at least one of:
a user having a predetermined association relationship with the first user,
a user community, the user community and the first user belonging to a same user group, or
one or more users who perform content collaboration with the first user.

20. A non-transitory computer-readable storage medium having a computer program stored thereon, wherein the computer program is executable by a processor to implement a method comprising:
in response to target content being shared to a chat, displaying, in an interface of the chat, a prompt message of the target content being shared; and
displaying, in association with the prompt message, sharing recommendation information indicating one or more objects.
